(19) United States
(12) Patent Application Publication
(10) Pub. No.: US 2012/0222266 A1
(43) Pub. Date: Sep. 6, 2012

(54) Felted castor

(76) Inventor: Marcel Brouard, Levis (CA)

(21) Appl. No.: 13/135,541

(22) Filed: Jul. 8, 2011

(30) Foreign Application Priority Data
Mar. 1, 2011 (CA) 2 733 198

(51) Int. Cl. B60B 33/00; B23P 17/04

(52) U.S. Cl. 16/45; 29/527.1

(57) ABSTRACT

The present invention concerns a felt covered castor put under a piece of furniture to make it roll on a floor. The castor comprises one or more wheels on which are fixed felt strips rolled up along the wheels. The use of the felt strip allows to brush slightly a surface of the floor and to protect it from scratches occurring at the passage of a naked wheel on the floor. And also it deafens the noise of the sliding wheel against the floor. Means of binding such as fusion or sticking are used to maintain firmly the felt strip on the wheel and to prevent it from getting loose.

### BACKGROUND OF THE INVENTION

This invention relates to the field of castors used under furniture to allow them to run on a floor.

### PRIOR ART

The present invention claims the priority of a canadian CA 2,733,198 filed on Mar. 1, 2011 by the same inventor and the same applicant.

A silent plastic anti-vibration castor, conceived in China, for use in a hospital environment with beds or wheel chairs is mentioned in on line shopping web sites, but we found no patent application for this product. No other previous technique is reported.

### OBJECTIVE

We notice that there is a need in the market for castors which would protect the floor from scratches caused by the sliding of a wheel on the floor, and which at the same time would offer a silent sliding. The present invention concerns a castor to install at the foot of a piece of furniture and which comprises a felt strip surrounding the wheel. The felt strip installed as well protects the floor and deafens the noise of the rolling of the wheel on the floor. The felt strip is maintained around the wheel by means of fusion fixing, as described in our patent CA 2,558,716 or by sticking or other means which would not damage the quality of the felt, nor its resistance to shear stress and its durability.

In the case of fusion, a felt strip is deposited against the internal walls of a mould inside which the material which will form the wheel is injected after cooling. A zone of intermediate fusion between this material and the felt strip is formed and links firmly the felt to the wheel.

In the case of sticking, the felt strip is strongly stuck on the wheel.

The present invention will be further understood from the following description with reference to the drawings.

### BRIEF DESCRIPTION OF DRAWINGS FIGURES

FIG. 1 is a castor with a felt pad over a wheel.

FIG. 2 is a cut of the felt around a wheel in a mould.

FIG. 3 is a felt with adhesive to apply to a wheel.

FIG. 4 is a perspective of a felted castor.

FIGS. 5A, 5B, 5C and 5D represent means of joining.

### DETAILED DESCRIPTION OF THE PREFERRED EMBODIMENTS

In the following description and in the accompanying drawings, the numeral numbers refer to identical parts in the various Figures.

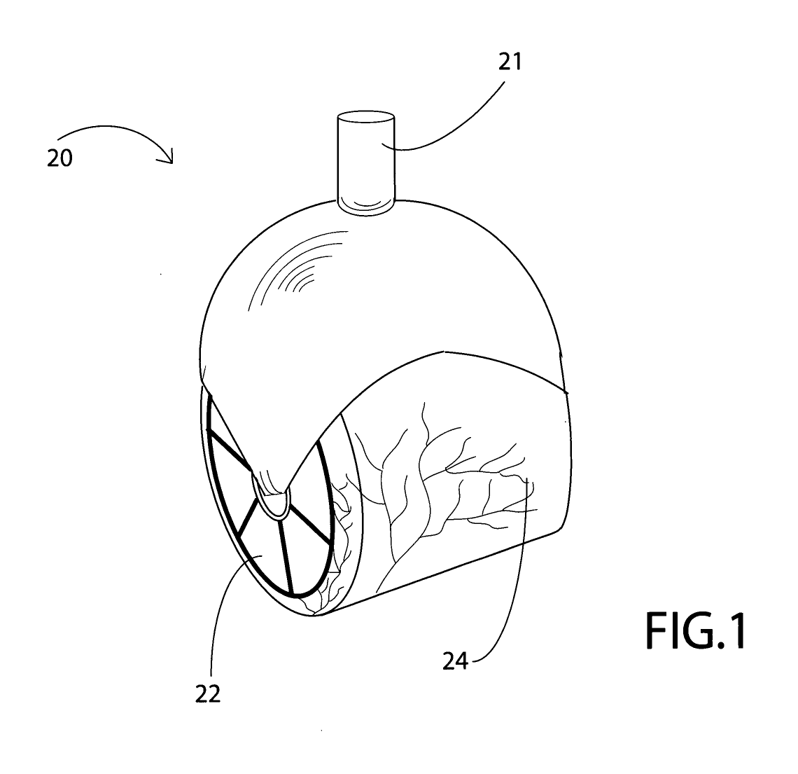

FIG. 1 shows a castor 20 with a tip 21 for insertion of a means of joining to a piece of furniture. The castor comprises a wheel 22 around which a felt strip 24 is fixed.

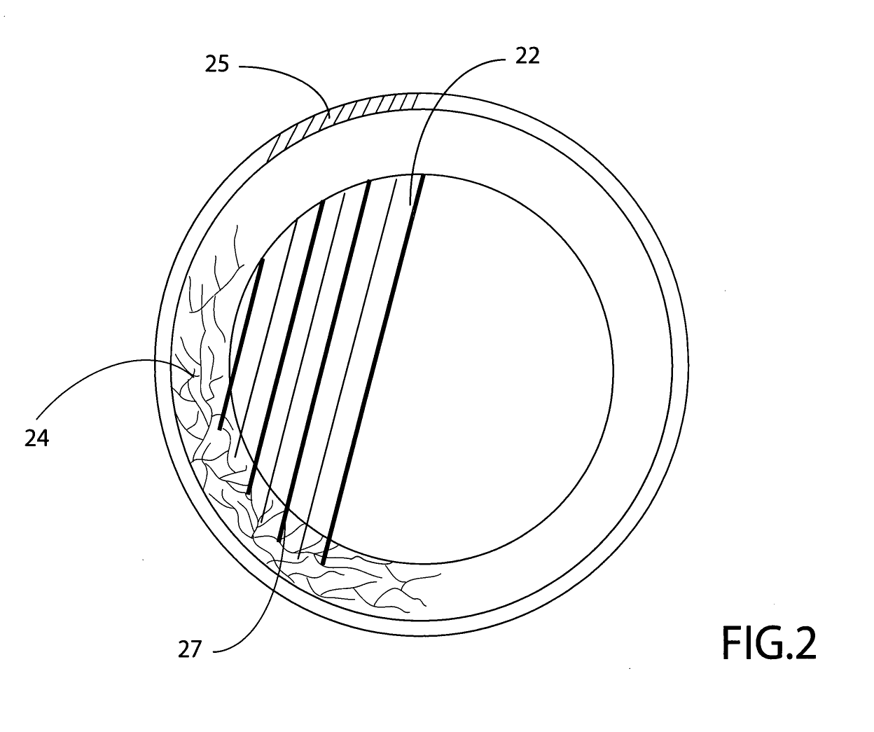

FIG. 2 shows a cut view of the wheel 22 poured into a mould 25 inside which the felt strip 24 is beforehand settled inside the mould. One sees a merged zone 27 comprising felt fibers mixed with particles of a wheel plastic.

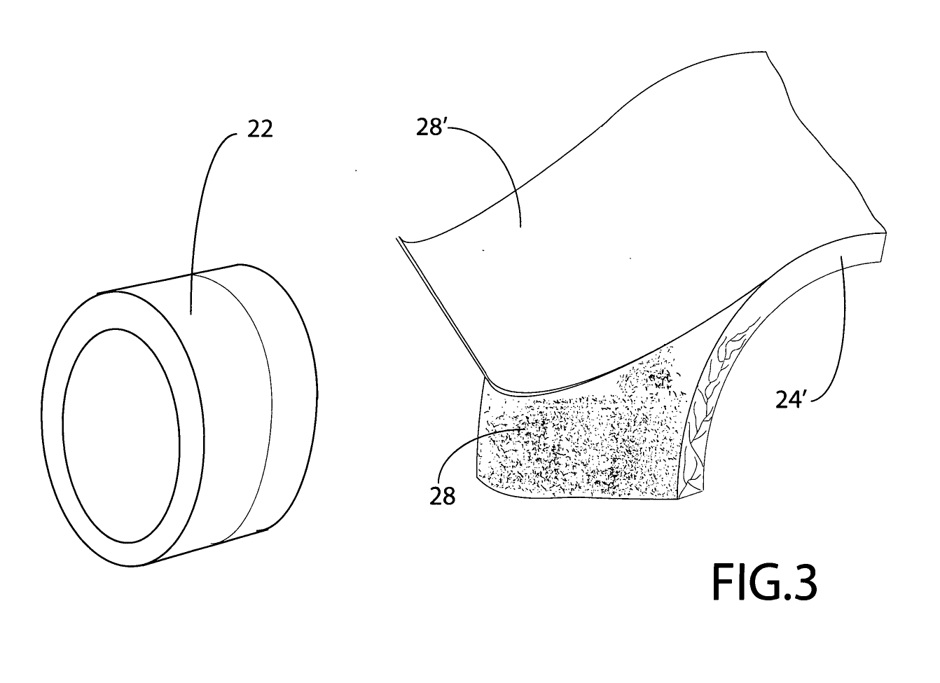

FIG. 3 shows a felt strip 24′ comprising on its top an adhesive 28, with a peel off cover 28′ ready to be stuck onto a wheel 22 of castor.

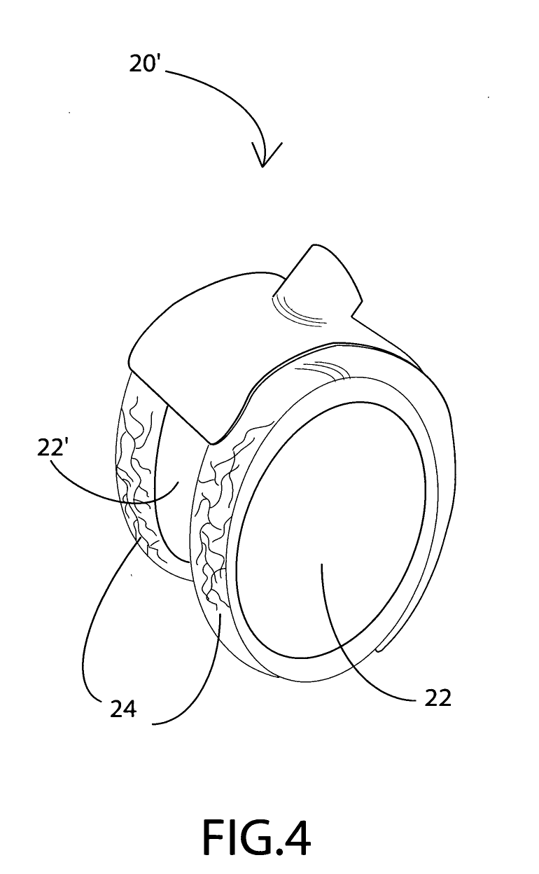

FIG. 4 shows a felted castor 20′ with two wheels 22, 22′ rolled up with a felt pad 24.

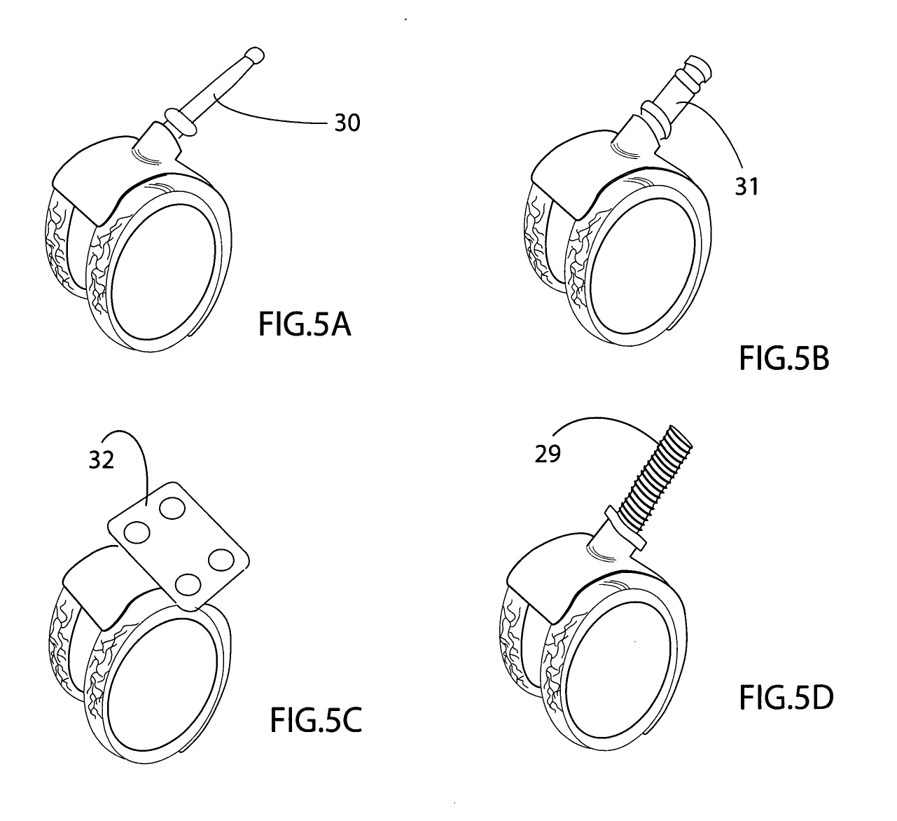

FIGS. 5A, 5B, 5C and 5D show felted castors with various means to attach to a piece of furniture. In FIG. 5A means to attach is a wood stalk 30, a friction stalk 31 in FIG. 5B, a plate 32 with openings for saws in FIG. 5C and a threaded stalk 29 in FIG. 5D.

### SUMMARY OF THE INVENTION

A felt pad to be used around a wheel of castor to protect from scratches floors on which a castor will roll. The felt pad will also allow deafening the noise of the rolling. The felt pad is firmly fixed to the periphery of a wheel by means of sticking or fusion during the casting of the wheel. The fusion is used to create a merged zone of felt fibers and particles of molten wheel plastic between the felt pad and the wheel of castor.

A combination of a wheel for a piece of furniture on castors and a layer of agglomerated material deposited around the wheel, the combination being intended to serve under the piece of furniture to protect a surface of a floor, the agglomerated layer comprising means to attach onto the wheel.

In the combination the agglomerated layer may be a felt pad.

The means to attach may be a fusion between the felt pad and the wheel producing a merged zone comprising fibers of the agglomerated layer merged with particles of a material of the wheel.

The material may be a plastic comprising a fusion zone merging with fibers of the felt pad.

A wheel for a piece of furniture on castors comprising a layer of agglomerated material disposed around the wheel, the wheel being intended to serve under the piece of furniture to protect a surface of a floor, the agglomerated layer comprising means to attach to the wheel.

The agglomerated layer may be a felt pad.

The means to attach is a fusion between the felt pad and the wheel thereby producing a merged zone comprising fibers of agglomerated materials merged with particles of the wheel.

A method of protection of a surface of a floor during a movement of a mobile element comprising the following steps:
a) dispose wheels under the mobile element;
b) dispose all around the wheels an agglomerated material intended to brush the floor to protect the surface;
c) choose for the agglomerated material a felt pad;
d) in a mould to produce the wheel, dispose the felt pad in a periphery of the mould and pour a material of the wheel into the space surrounded by the felt pad. The step numbered d) in the above method may be preceded by a step of sticking which consists in sticking the felt pad around the wheel.

The wheel may be fixed under the piece of furniture by means of a plate. It may be fixed by means of a wood stalk; by means of a threaded stalk; by means of a friction stalk.

It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the following claims.

### PARTS

20, 20′ Felted castors
21 Tip
22, 22′ Wheels of castor
24 Felt
24′ Felt with an adhesive on the top
25 Mould
27 Merged zone
28 Peel of adhesive
28′ Adhesive peel-off cover
29 Threaded stalk
30 Wood stalk
31 Friction stalk
32 Plate

I claim:

1. A combination of a wheel for a piece of furniture on castors and a layer of agglomerated material deposited around said wheel, said combination being intended to serve under said piece of furniture to protect a surface of a floor, said agglomerated layer comprising means to attach onto said wheel.

2. The combination of claim 1 wherein said agglomerated layer is a felt pad.

3. The combination of claim 2 wherein said means to attach is a fusion between said felt pad and said wheel producing a merged zone comprising fibers of said agglomerated layer merged with particles of a material of said wheel.

4. A wheel for a piece of furniture on castors comprising a layer of agglomerated material disposed around said wheel, said wheel being intended to serve under said piece of furniture to protect a surface of a floor, said agglomerated layer comprising means to attach to said wheel.

5. The wheel of claim 4 wherein said agglomerated layer is of a felt pad.

6. The wheel of claim 5 wherein said means to attach is a fusion between said felt pad and said wheel thereby producing a merged zone comprising fibers of agglomerated materials merged with particles of said wheel.

7. A method of protection of a surface of a floor during a movement of a mobile element comprising the following steps:
a) Arrange wheels under said mobile element;
b) Dispose all around said wheels an agglomerated material intended to brush said floor to protect said surface;
c) Choose for said agglomerated material a felt pad;
d) In a mould to produce said wheel, dispose said felt pad in a periphery of said mould and pour a material of said wheel into the space surrounded by said felt pad;
e) Said felt pad is firmly sticked around said wheel.

8. The wheel of claim 4 fixed under said piece of furniture by means of a plate.

9. The wheel of claim 4 fixed under said piece of furniture by means of a wood stalk.

10. The wheel of claim 4 fixed under said piece of furniture by means of a threaded stalk.

11. The wheel of claim 4 fixed under said piece of furniture by means of a friction stalk.
